(19) United States
(12) Patent Application Publication
(10) Pub. No.: US 2026/0349439 A1
(43) Pub. Date: Nov. 5, 2026

(54) AUTONOMOUS MOBILE MACHINE CONTROL METHOD, AUTONOMOUS MOBILE MACHINE, AND MANAGEMENT SYSTEM

(71) Applicant: VisionNav Robotics USA Inc., Acworth, GA (US)

(72) Inventors: Bingchuan YANG, Acworth, GA (US); Shuyu GU, Acworth, GA (US); Fan ZHANG, Acworth, GA (US); Lisha HUANG, Acworth, GA (US); Qiyuan ZHAO, Acworth, GA (US)

(21) Appl. No.: 19/196,054

(22) Filed: May 1, 2025

(51) Int. Cl. G05D 1/648; G05D 1/667; G05D 107/70

(52) U.S. Cl. CPC G05D 1/648; G05D 1/667; G05D 2107/70

(57) ABSTRACT

An autonomous mobile machine control method, an autonomous mobile machine, and a management system are disclosed. The autonomous mobile machine control method includes: obtaining a first text file; obtaining task information from the first text file; determining whether the task information includes specified information, where the specified information specifies an autonomous mobile machine for executing a task; and in response to that the task information does not include the specified information, scheduling the autonomous mobile machine to execute the task.

### TECHNICAL FIELD

The present disclosure relates to the field of autonomous mobile machines, and specifically, to an autonomous mobile machine control method, an autonomous mobile machine, and a management system.

### BACKGROUND

In the existing technology, a control system for controlling an autonomous mobile machine has a low operation efficiency and high costs, causing much inconvenience to a user.

### BRIEF DESCRIPTION OF THE DRAWINGS

The accompanying drawings are used for further understanding of the present disclosure, constitute a part of the description, and are used together with the following specific embodiments to interpret the present disclosure, but do not constitute a limitation to the present disclosure. In the accompanying drawings:

FIG. 1A is a schematic block diagram showing a management system according to an embodiment of the present disclosure.

FIG. 1B is a schematic diagram showing that an autonomous mobile machine is applied to a warehouse according to an embodiment of the present disclosure.

FIG. 2 is a flowchart showing an autonomous mobile machine control method according to an embodiment of the present disclosure.

FIG. 3A is a flowchart showing a method of step 202 according to an embodiment of the present disclosure.

FIG. 3B is a flowchart showing a method of step 202 according to another embodiment of the present disclosure.

FIG. 4 is a flowchart showing a method of step 204 according to an embodiment of the present disclosure.

### DETAILED DESCRIPTION

The following disclosure provides a plurality of implementations or examples, which can be used to implement different features of the present disclosure. Specific examples of components and configurations described below are used to simplify the present disclosure. It may be conceived that these descriptions are merely for exemplary purposes, and are not intended to limit the present disclosure. For example, in the following description, a first feature being formed on or above a second feature may include some embodiments in which the first feature and the second feature are in direct contact with each other; or may include some embodiments in which an additional component is formed between the first feature and the second feature, so that the first feature and the second feature may not be in direct contact. In addition, in the present disclosure, component symbols and/or numbers may be repeatedly used in a plurality of embodiments. The repeated use is based on an objective of brevity and clarity, and does not represent a relationship between the different discussed embodiments and/or configurations.

In addition, relative spatial terms used herein, such as “under”, “below”, “lower than”, “on”, “above”, and the like may be used for ease of describing a relationship between one component or feature shown in the figure and another component or feature. These relative spatial words are intended to cover a plurality of different orientations of the apparatus during use or operation in addition to the orientations shown in the figures. The device may be placed at another orientation (for example, rotated by 90 degrees or at another orientation), and these relative spatial description words should be correspondingly interpreted.

Although numerical ranges and parameters used to define the broad scope of the present disclosure are approximate values, relevant values in specific embodiments are presented as precisely as possible herein. However, any value essentially, inevitably contains a standard deviation caused by an individual test method. Herein, “approximately” usually means that an actual value is within ±10%, ±5%, ±1%, or ±0.5% of a particular value or range. Alternatively, the term “approximately” represents that the actual value falls within an acceptable standard error of a mean, and is determined by consideration of a person of ordinary skill in the art to which the present disclosure relates. It may be understood that, except experimental examples, or unless otherwise clearly stated, all ranges, amounts, values, and percentages used herein (for example, for describing an amount of a material, a duration, a temperature, an operating condition, a quantity ratio, and the like) are modified by “approximately”. Therefore, unless otherwise specified on the contrary, numerical parameters disclosed in this specification and appended claims are approximate values, and may be changed according to requirements. These numerical parameters should be understood as at least a specified quantity of valid digits and a numerical value obtained by using a common carry method. Herein, the value range is indicated as from one endpoint to the other endpoint or between two endpoints. Unless otherwise specified, the numerical range described herein includes the endpoints.

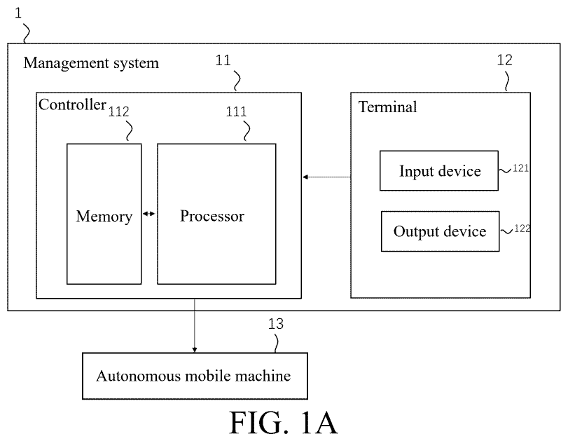

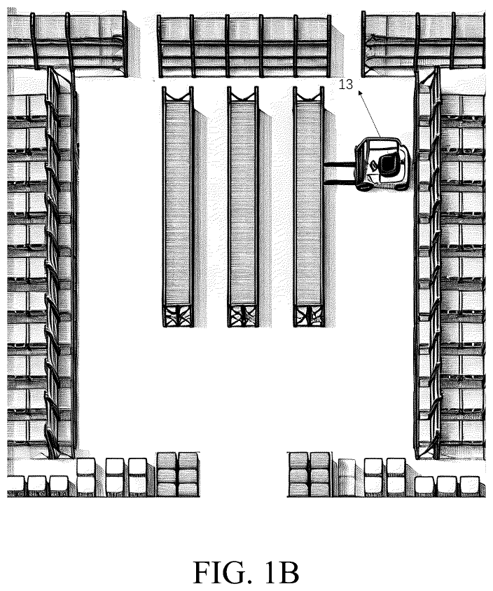

FIG. 1A is a schematic block diagram of a management system 1 according to an embodiment of the present disclosure. In some embodiments, the management system 1 includes a controller 11 and a terminal 12. In some embodiments, the management system 1 is configured to schedule an autonomous mobile machine 13, so that the autonomous mobile machine 13 completes a task delivered by a user by using the terminal 12. It should be noted that the autonomous mobile machine 13 shown in FIG. 1A represents an autonomous mobile machine or an autonomous mobile machine group. In other words, the management system 1 is configured to schedule one or more autonomous mobile machines 13 in a group.

In some embodiments, both the controller 11 and the terminal 12 of the management system 1 shown in FIG. 1A may be integrated into an autonomous mobile machine 13 for implementation. In some embodiments, the whole management system 1 (including the controller 11 and the terminal 12) may be integrated on one autonomous mobile machine 13, and other autonomous mobile machines 13 are scheduled by using the management system 1 on the autonomous mobile machine 13. In some embodiments, the controller 11 may be disposed on one autonomous mobile machine 13, and the terminal 12 is disposed at another position (for example, another autonomous mobile machine 13 or another position suitable for arranging the terminal 12). In other words, the autonomous mobile machine control method provided in the present disclosure (which is to be described in subsequent embodiments) may be performed completely by using one or more autonomous mobile machines 13.

In some embodiments, a user delivers an instruction to the management system 1 by using the terminal 12. In some embodiments, the terminal 12 includes an input device 121 and an output device 122. In some embodiments, the input device 121 may include a voice receiver (for example, a microphone) or a text input unit (for example, a keyboard or a touchscreen). In some embodiments, the output device 122 may include a speaker, a display screen, or the like. In some embodiments, a user delivers, to the management system 1 in voice mode, a task instruction to be executed by the autonomous mobile machine 13, and the task instruction is received by the voice receiver. In some embodiments, a user may alternatively deliver, to the management system 1 by operating a touchscreen, a task instruction to be executed by the autonomous mobile machine 13. After the task is ended, the management system 1 may report a task result to the user by sending a voice by using the speaker, or may report a task result to the user by displaying the task result by using the display screen.

In some embodiments, the autonomous mobile machine 13 includes a mobile device capable of autonomously or semi-autonomously executing a task, and has an autonomous moving and navigating capability. Common forms of the autonomous mobile machine 13 include: an automatic guided vehicle (AGV), an autonomous mobile robot (AMR), a humanoid robot, and the like, or may include other forms such as an intelligent car and a sweeping robot. Specifically, the autonomous mobile machine 13 may alternatively be an unmanned vehicle applied to a warehouse, for example, an automated guided forklift. Referring to FIG. 1B, FIG. 1B is a schematic diagram showing that an autonomous mobile machine 13 is applied to a warehouse according to an embodiment of the present disclosure. The autonomous mobile machine 13 may take goods from a warehouse area according to an instruction, precisely place the goods at a designated location, and implement a dynamically planned route based on real time data under scheduling of the management system 1, to avoid collision and improve the operation efficiency. It should be noted that the implementation of the autonomous mobile machine 13 shown in FIG. 1B is merely used for exemplary description, and does not constitute an only limitation to the present disclosure. In addition, the autonomous mobile machine 13 is not limited to being applied to an unmanned vehicle. In other embodiments, the autonomous mobile machine 13 may be any intelligent mobile apparatus.

In some embodiments, the controller 11 is configured to analyze the task instruction delivered by the user by using the terminal 12, and schedule the autonomous mobile machine 13 to complete the task. In some embodiments, the controller 11 includes a processor 111 and a memory 112. In some embodiments, the processor 111 is operatively coupled to the memory 112. In some embodiments, the processor 111 may be an integrated element. The processor 111 may include a plurality of processing units. The processor 111 may include a computing unit or a core computing unit. The processor 111 may be configured to load data information from the memory 112. The processor 111 may store the data information to the memory 112. The processor 111 may receive data from another hardware device. The processor 111 may process data from another hardware device.

In some embodiments, the memory 112 may be an integrated element. The memory 112 may be considered as including a plurality of storage units, and information may be respectively stored in different storage units or stored in a same storage unit.

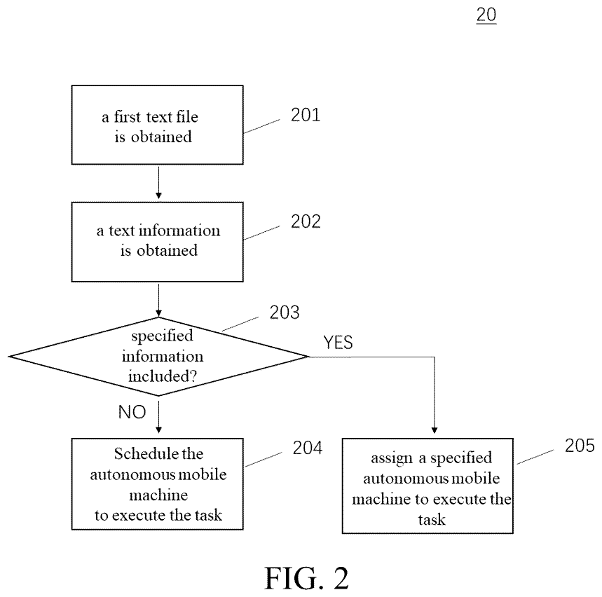

FIG. 2 is a flowchart showing an autonomous mobile machine control method 20 according to an embodiment of the present disclosure. If approximately the same result can be obtained, the present disclosure is not limited to being performed completely according to the steps of the process shown in FIG. 2. In some embodiments, the steps of the autonomous mobile machine control method 20 may be performed by different processing units or a same processing unit in the processor 111.

In some embodiments, the autonomous mobile machine control method 20 includes step 201, step 202, step 203, step 204, and step 205.

In some embodiments, in step 201, the processor 111 may obtain a first text file from the terminal 12. In some embodiments, the first text file carries task information. In some embodiments, the first text file may be obtained by converting a command file. In some embodiments, the command file is a voice type file, and the first text file is a text type file. In some embodiments, the command file is a voice type file in a wav format, and the first text file is a text type file in a txt format. In some embodiments, the command file is a voice instruction delivered by a user to the terminal 12 in voice mode. In some embodiments, a voice-to-text conversion module of the processor 111 converts the command file in the voice type into a first text file in a text type. In some embodiments, a user may log into a web page by using the terminal 12, and complete voice delivery by using a voice control button on the web page.

In some embodiments, the voice-to-text conversion module is not limited to being integrated into the processor 111. In some embodiments, the processor 111 may send a domain name to the voice-to-text conversion module, and the voice-to-text conversion module obtains a command file in a voice type in the domain name for text conversion, and places the converted first text file onto the domain name for the processor 111 to access.

In other embodiments, a fronted file may alternatively be a program code instruction generated by the terminal 12 after a user performs an operation on a touchscreen.

In some embodiments, in step 202, the processor 111 may obtain task information from the first text file. In some embodiments, the processor 111 captures, from the first text file, the task information delivered by the user. In some embodiments, a semantic interpreting module of the processor 111 obtains semantic information after analyzing the first text file, and obtains the task information from the semantic information.

In some embodiments, the semantic interpreting module is not limited to being integrated into the processor 111. In some embodiments, the processor 111 may send the domain name to the semantic interpreting module, so that the semantic interpreting module obtains the first text file in the text type in the domain name so as to obtain the task information, and places the task information onto the domain name for the processor 111 to access.

In some embodiments, after the semantic interpreting module analyzes the first text file, when the processor 111 determines that an error exists in the semantic information, the processor 111 may send error reporting information to the terminal 12, so as to remind the user to again deliver a command. For example, when the semantic information is blank, the processor 111 reads an error reporting information file from the memory 112, converts error reporting information into a voice file by using a text-to-voice conversion module of the processor 111, and then sends the voice file to the terminal 12, so as to notify a user by sending a voice by using a speaker.

In some embodiments, in step 203, the processor 111 may determine whether the task information includes specified information, and if yes, step 205 is performed; or otherwise, step 204 is performed. In some embodiments, the specified information is used for instructing a particular autonomous mobile machine 13 to execute a task. In some embodiments, in step 204, the processor 111 may schedule, in response to that the task information does not include the specified information, the autonomous mobile machine 13 to execute the task. In some embodiments, when a user does not specify a particular autonomous mobile machine 13 (that is, the task information does not include the specified information), the processor 111 may schedule any autonomous mobile machine 13 to execute the task. In some embodiments, in step 205, the processor 111 may assign, in response to that the task information includes the specified information, a specified autonomous mobile machine 13 to execute the task.

In some embodiments, the task issued by the user may be a control-type task or an execution-type task. In some embodiments, when the task is a control-type task, the task information may include action information. The action information is used for instructing the autonomous mobile machine 13 to suspend an action, continue performing an action, or cancel an action. For example, when an emergency occurs, a user may issue a task to require all autonomous mobile machines 13 to suspend tasks that are being executed currently. After the emergency is ruled out, the user again issues a task to require all of the autonomous mobile machines 13 to continue a previous mobile task, or cancel a previous mobile task.

In some embodiments, when the task is a control-type task, the task information may further include specified information, where the specified information is used for specifying a particular autonomous mobile machine 13. For example, a user may issue a task to require a particular autonomous mobile machine 13 to suspend a task that is currently being executed, so as to check the autonomous mobile machine 13. After the check is completed, the user issues a task to require the autonomous mobile machine 13 to continue a previous task, or cancel a previous task.

In some embodiments, when the task is an execution-type task, the task information may include action information, task location information, and information about the number of times of execution. The action information is used for instructing the autonomous mobile machine 13 to perform at least one or a combination of a goods taking action, a goods placing action, or a charging action. The task location information is used for indicating a location where the autonomous mobile machine 13 performs the task. The information about the number of times of execution is used for indicating the number of times of execution performed by the autonomous mobile machine 13. For example, the user may issue a task to require any autonomous mobile machine 13 to head to a particular warehouse (for example, a No. 1 warehouse) to take goods, and to execute the action for a particular number of times (for example, taking goods for three times).

In some embodiments, when the task is an execution-type task, the task information may further include specified information, where the specified information is used for specifying a particular autonomous mobile machine 13. For example, the user may issue a task to require a particular autonomous mobile machine 13 (for example, a No. 1 autonomous mobile machine) to head to a particular warehouse (for example, a No. 1 warehouse) to take goods, and to execute the action for a particular number of times (for example, taking goods for three times). For example, a user may issue a task to require a particular autonomous mobile machine 13 (for example, a No. 1 autonomous mobile machine) to head to a particular charging position (for example, a No. 1 charging position) for charging.

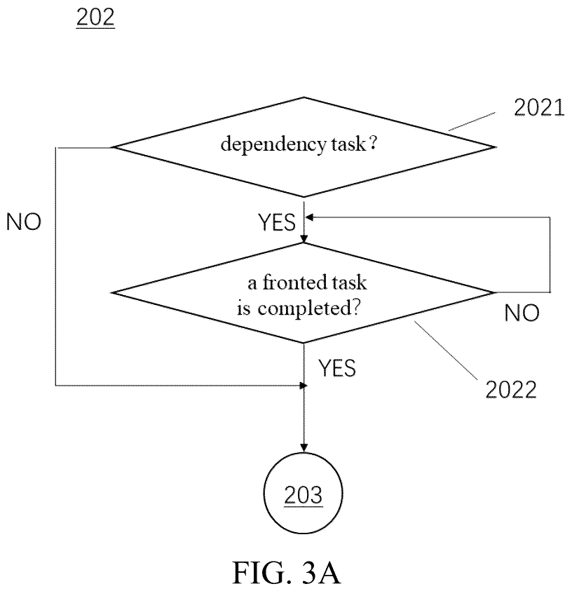

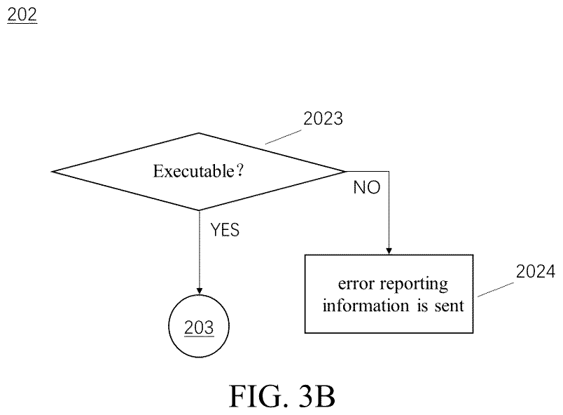

FIG. 3A is a flowchart showing a method of step 202 according to an embodiment of the present disclosure. If approximately the same result can be obtained, the present disclosure is not limited to being performed completely according to the steps of the process shown in FIG. 3A. In some embodiments, step 202 includes step 2021 and step 2022.

In some embodiments, in step 2021, the processor 111 may determine whether the task is a dependency task; and if yes, step 2022 is performed; or otherwise, step 203 is performed. In some embodiments, the dependency task represents that the task can be executed only after all related fronted tasks are completed. In some embodiments, in step 2022, the processor 111 may determine, in response to that the task is a dependency task, whether a fronted task is completed; if yes, step 203 is performed; or otherwise, step 2022 is again performed.

For example, the user may issue a task to require the autonomous mobile machine 13 to place goods B on goods A in the No. 1 warehouse. In this case, [placing the goods A in the No. 1 warehouse] is a fronted task of [placing the goods B on the goods A in the No. 1 warehouse]. Therefore, the processor 111 determines that the task is a dependency task. Next, the processor 111 determines whether the goods A has been placed in the No. 1 warehouse. Only when the goods A is already placed in the No. 1 warehouse, the processor 111 determines, according to step 203, whether the task information includes the specified information. Next, the processor 111 schedules the autonomous mobile machine 13 to execute the task of [placing the goods B on the goods A in the No. 1 warehouse].

In some embodiments, the fronted task may include a plurality of tasks. For example, the fronted task may include a first fronted task [placing A in the No. 1 warehouse] and a second fronted task [placing the goods B on the goods A in the No. 1 warehouse], and the user may issue a task to require the autonomous mobile machine 13 to place goods C on the goods B in the No. 1 warehouse. It may be understood that only after the processor 111 determines that the goods A is already placed in the No. 1 warehouse and the goods B is already placed on the goods A, the processor 111 determines whether the task information includes the specified information according to step 203. Next, the processor 111 schedules the autonomous mobile machine 13 to execute the task of [placing the goods C on the goods B in the No. 1 warehouse].

For example, the fronted task may include a first fronted task [transferring the goods A to a No. 2 warehouse at 12 o'clock], a second fronted task [transferring the goods A to the No. 1 warehouse at 12:30], and a third fronted task [placing the goods B on the goods A in the No. 1 warehouse]. The user may issue a task to require the autonomous mobile machine 13 to place the goods C on the goods B in the No. 1 warehouse. It may be understood that only after the processor 111 determines that the goods A is already transferred to the No. 2 warehouse and the No. 1 warehouse at 12 o'clock and 12:30, respectively, and the goods B is already placed on the goods A, the processor 111 determines, according to step 203, whether the task information includes the specified information. Next, the processor 111 schedules the autonomous mobile machine 13 to execute the task of [placing the goods C on the goods B in the No. 1 warehouse].

FIG. 3B is a flowchart showing a method of step 202 according to another embodiment of the present disclosure. If approximately the same result can be obtained, the present disclosure is not limited to being performed completely according to the steps of the process shown in FIG. 3B. In some embodiments, step 202 includes step 2023 and step 2024.

In some embodiments, in step 2023, the processor 111 may determine whether the task is executable; if yes, step 203 is performed, or otherwise, step 2024 is performed. In some embodiments, a task issued by a user may not be executable. For example, when a user issues a task to require a particular autonomous mobile machine 13 (for example, a No. 1 autonomous mobile machine) to head to a No. 1 charging position for charging. In this case, if the No. 1 charging position is being used by another autonomous mobile machine or cannot be used due to factors such as a fault, the task cannot be executed. For example, if a user issues a task to require a particular autonomous mobile machine 13 (for example, a No. 1 autonomous mobile machine) to head to a No. 10 warehouse to take goods, but the No. 10 warehouse does not exist, the task cannot be executed. For example, the user issues a task to require any autonomous mobile machine 13 to head to the No. 1 warehouse to obtain the goods A. In this case, if the goods A is not in the No. 1 warehouse, the task cannot be executed.

In some embodiments, in step 2024, the processor 111 may send error reporting information to the terminal 12, so as to notify the user that the task information is erroneous. After the processor 111 determines that the task issued by the user cannot be executed, the processor 111 sends the error reporting information to the terminal 12 so as to notify the user that the task information is erroneous. In some embodiments, when the processor 111 needs to send the error reporting information to the terminal 12, a user may be notified by sending a voice by using a speaker. In some embodiments, when the processor 111 needs to send the error reporting information to the terminal 12, the processor 111 may read an error reporting information file from the memory 112, convert the error reporting information into a voice file by using a text-to-voice conversion module of the processor 111, and then send the voice file to the terminal 12, so as to notify a user by sending a voice by using a speaker. In some embodiments, when the processor 111 needs to send the error reporting information to the terminal 12, the processor 111 may alternatively notify the user by displaying the error reporting information on the display screen. In some embodiments, when the processor 111 needs to send the error reporting information to the terminal 12, the processor 111 may read an error reporting information file from the memory 112, send text in the error reporting information file to the terminal 12, and notify the user by displaying the text of the error reporting information file on the display screen.

In other embodiments, after the processor 111 determines that the task is executable in step 2023, the processor 111 may similarly send task acceptance success information to the terminal 12, so as to notify the user. In some embodiments, when the processor 111 needs to send the task acceptance success information to the terminal 12, the processor 111 may read answer text from the memory 112, convert the task acceptance success information into a voice file by using a text-to-voice conversion module of the processor 111, and then send the voice file to the terminal 12, so to the user by sending a voice by using the speaker. In some embodiments, when the processor 111 needs to send the task acceptance success information to the terminal 12, the processor 111 may read answer text from the memory 112, and send text in the answer text to the terminal 12, so as to notify the user by displaying the text of the answer text on the display screen.

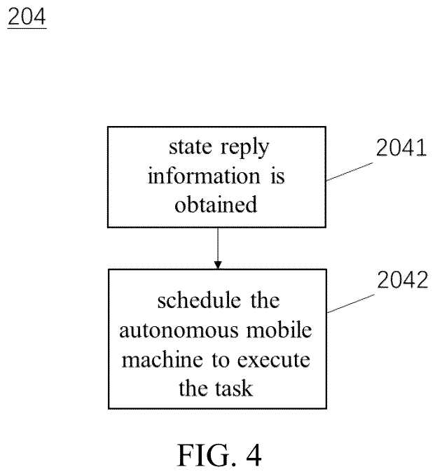

FIG. 4 is a flowchart showing a method of step 204 according to an embodiment of the present disclosure. If approximately the same result can be obtained, the present disclosure is not limited to being performed completely according to the steps of the process shown in FIG. 4. In some embodiments, step 204 includes step 2041 and step 2042.

In some embodiments, in step 2041, the processor 111 may obtain state reply information of an autonomous mobile machine 13 that meets a task execution condition. In some embodiments, the state reply information may include a location, a task in execution, and an amount of electricity of the autonomous mobile machine 13. In some embodiments, in step 2042, the processor 111 may schedule, according to the state reply information, the autonomous mobile machine 13 for executing the task.

For example, when a user issues a task to require any autonomous mobile machine 13 to head to a particular warehouse (for example, a No. 1 warehouse) to take goods, and executes the action for a particular number of times (for example, taking goods for three times). Due to the fact that no particular autonomous mobile machines 13 are required to execute the action (that is, the task information does not include the specified information), the processor 111 may schedule any autonomous mobile machine 13 to execute the task. In view of the need of heading to a warehouse to take goods, an autonomous mobile machine 13 already carrying goods cannot perform goods taking and therefore does not meet a task execution condition. In this case, the processor 111 does not schedule an autonomous mobile machine 13 that does not meet the task execution condition to execute the task. An autonomous mobile machine 13 carrying no goods meets the task execution condition. In this case, the processor 111 obtains state reply information of the autonomous mobile machine 13 that meets the task execution condition, and selects, according to a location, a task in execution, and an amount of electricity of each autonomous mobile machine 13 that meets the task execution condition, a most optimal autonomous mobile machine 13 to execute the task.

In some embodiments, the processor 111 may preferentially schedule, among autonomous mobile machines 13 that meet the task execution condition, an autonomous mobile machine 13 closest to the task location to execute the task. In some embodiments, the processor 111 may calculate, by using a space-time search algorithm, a route and a control time sequence for the autonomous mobile machine 13 to execute the task. The control time sequence represents a time interval in which the autonomous mobile machine 13 occupies each route segment, so as to ensure that there is no route conflict relationships between every two autonomous mobile machines 13 among all of the autonomous mobile machines 13 at a same moment in a time-line, and in addition, a total time for completing the entire task is as short as possible.

In some embodiments, the amount of electricity of the autonomous mobile machine 13 is further considered at the processor 111. If it is determined that the amount of electricity of the autonomous mobile machine 13 closest to the task location is insufficient to complete the task, an autonomous mobile machine 13 second closest to the task location is considered to execute the task.

In some embodiments, the task information may further include priority information, where the priority information is used for indicating a priority of the task. When the task has the highest priority, the processor 111 may cancel a current task of the autonomous mobile machine 13 closest to the task location, and prioritizes the task having the highest priority.

In some embodiments, the task issued by the user may alternatively be a question-answer type task. The question-answer type task does not require the processor 111 to schedule the autonomous mobile machine 13. In some embodiments, when the task is a question-answer type task, the processor 111 may obtain state reply information from the autonomous mobile machine 13 or obtain answer text from the memory 112. In some embodiments, the question-answer type task may include other topics or topics that have been fine-tuned by using a model. In some embodiments, the fine-tuned topics refer to some fixed topics that need to be selected according to an actual scenario, and differ from other topics in that databases used for answering are different.

In some embodiments, if the topic is another topic, a reasoning module of the processor 111 performs reasoning to obtain answer text for answering. If the topic is a fine-tuned topic, the processor 111 first determines whether state reply information needs to be received from a particular autonomous mobile machine 13 as answer content; and if the state reply information needs to be received from the particular autonomous mobile machine 13, the state reply information is received from the corresponding autonomous mobile machine 13; or otherwise, a semantic interpreting module of the processor 111 obtains answer text according to the fine-tuned data for answering.

For example, a user may issue a task to query a current amount of electricity of a particular autonomous mobile machine 13 (for example, a No. 1 autonomous mobile machine 13). Such the question-answer type task belongs to the fine-tuned topics, and needs to receive state reply information from a corresponding autonomous mobile machine 13 as answer content. Therefore, after receiving the task information, the processor 111 obtains the state reply information of the No. 1 autonomous mobile machine 13, so as to learn about a current amount of electricity of the No. 1 autonomous mobile machine 13, and send an answer to the terminal 12. For example, the user may issue a task to query a function of the autonomous mobile machine 13. Such the question-answer type task belongs to the fine-tuned topics, and does not need to receive state reply information from a corresponding autonomous mobile machine 13 as answer content. Therefore, after the processor 111 receives the task information, a semantic interpreting module of the processor 111 provides answer text according to the fine-tuned data and sends an answer to the terminal 12. For example, the user may issue a task to query current weather. Such the type of question-answer type task belongs to the other topics. Therefore, after the processor 111 receives the task information, the reasoning module of the processor 111 may perform reasoning to obtain the answer text for answering.

In some embodiments, after the autonomous mobile machine 13 completes the task delivered by the user, the processor 111 may send task success information to the terminal 12, so as to notify the user. In some embodiments, when the processor 111 needs to send the task success information to the terminal 12, the processor 111 may read answer text from the memory 112, convert the task success information into a voice file by using the text-to-voice conversion module of the processor 111, and then send the voice file to the terminal 12, so to notify a user by sending a voice by using a speaker. In some embodiments, when the processor 111 needs to send the task success information to the terminal 12, the processor 111 may read answer text from the memory 112, and send text in the answer text to the terminal 12, so as to notify the user by displaying the text of the answer text on the display screen.

As used in this specification, the terms “likely”, “substantially”, “basically”, and “approximately” are used to describe and consider small variations. When used in combination with an event or situation, the terms may refer to an example in which the event or situation precisely occurs and an example in which the event or situation most likely occurs. As used herein with respect to a specified value or range, the term “approximately” generally means within ±10%, ±5%, ±1%, or ±0.5% of the specified value or range. Ranges may be expressed as from one endpoint to the other endpoint, or between two endpoints. Unless otherwise specified, all ranges disclosed herein include endpoints. The term “substantially coplanar” may refer to two surfaces that are located along a same plane and are within a few micrometer (μm), for example, located along a same plane and are within 10 μm, 5 μm, 1 μm, or 0.5 μm. When referring to “substantially” the same value or feature, the term may refer to a value that is within ±10%, ±5%, ±1%, or ±0.5% of a mean of the values.

As used in this specification, the terms “likely”, “basically”, “basically”, and “approximately” are used to describe and explain small variations. When used in combination with an event or situation, the terms may refer to an example in which the event or situation precisely occurs and an example in which the event or situation most likely occurs. In some embodiments, when used in combination with a value, a term may refer to a variation range of less than or equal to ±10% of the value, for example, less than or equal to ±5%, less than or equal to ±4%, less than or equal to ±3%, less than or equal to ±2%, less than or equal to ±1%, less than or equal to ±0.5%, less than or equal to ±0.1%, or less than or equal to ±0.05%. In some embodiments, if a difference between two values is less than or equal to ±10% (for example, less than or equal to ±5%, less than or equal to ±4%, less than or equal to ±3%, less than or equal to ±2%, less than or equal to ±1%, less than or equal to ±0.5%, less than or equal to ±0.1%, or less than or equal to ±0.05%) of a mean of the values, the two values may be considered to be “substantially” or “approximately” the same. In some embodiments, “substantially” parallel may refer to an angle variation range less than or equal to ±10° relative to 0°, for example, less than or equal to ±5°, less than or equal to ±4°, less than or equal to ±3°, less than or equal to ±2°, less than or equal to ±1°, less than or equal to ±0.5°, less than or equal to ±0.1°, or less than or equal to ±0.05°. In some embodiments, “substantially” perpendicular may refer to an angle variation range less than or equal to ±10° relative to 90°, for example, less than or equal to ±5°, less than or equal to ±4°, less than or equal to ±3°, less than or equal to ±2°, less than or equal to ±1°, less than or equal to ±0.5°, less than or equal to ±0.1°, or less than or equal to ±0.05°.

In some embodiments, if a displacement between two surfaces is equal to or less than 5 μm, equal to or less than 2 μm, equal to or less than 1 μm, or equal to or less than 0.5 μm, the two surfaces may be considered to be coplanar or substantially coplanar. If a displacement between any two points of the surface relative to the plane on the surface is equal to or less than 5 μm, equal to or less than 2 μm, equal to or less than 1 μm, or equal to or less than 0.5 μm, the surface may be considered to be planar or substantially planar.

As used in this specification, unless clearly stipulated in the context, singular terms “a”, “an”, and “the” may include plural indicators. In description of some embodiments, a component provided “on” or “above” another component may cover a case in which the former component is directly on the latter component (for example, being in physical contact with the latter component), and a case in which one or more intermediate components are located between the former component and the latter component.

As used in this specification, for ease of description, relative spatial terms such as “under”, “below”, “lower portion”, “above”, “upper portion”, “lower portion”, “left”, and “right” may be used in this specification to describe a relationship between one component or feature and another component or feature as illustrated in the accompanying drawings. In addition to the orientations depicted in the figure, the spatial relative terms are intended to cover different orientations of an apparatus during use or operation. The device may be oriented in another orientations (rotated by 90 degrees or at another orientation), and the relative spatial descriptors used in this specification may alternatively be correspondingly explained. It should be understood that when a component is referred to as being “connected to” or “coupled to” another component, the component may be directly connected to or coupled to the another component, or an intermediate component may exist.

The foregoing summarizes the features of several embodiments and detailed aspects of the present disclosure. The embodiments described in the present disclosure can be easily used as a basis for designing or modifying other processes and a structure for performing the same or similar objectives and/or obtaining the same or similar advantages of the embodiments introduced in the present disclosure. These equivalent constructs do not depart from the spirit and scope of the present disclosure, and different changes, replacements, and changes may be made without departing from the spirit and scope of the present disclosure.

1. An autonomous mobile machine control method for controlling autonomous mobile machines to execute tasks, comprising:
obtaining a command file and converting the command file to obtain a first text file, wherein the command file is a voice type file and the first text file is a text type file;
obtaining task information from the first text file;
determining whether the task information comprises specified information, wherein the specified information is configured to specify an autonomous mobile machine for executing a task;
in response to that the task information does not comprise the specified information, controlling one of the autonomous mobile machines by transmitting signals through a processor, to cause said one of the autonomous mobile machines to execute the task;
obtaining a semantic information by analyzing the first text file;
determining whether an error exists in the semantic information;
in response to an error exists in the semantic information, sending an error reporting information file to a terminal to remind a user to again deliver a command;
in response to the error does not exist in the semantic information, causing said one of the autonomous mobile machines to execute the task;
determining whether the task is executable by assessing the relationship between a target associated with the task and environment;
in response to that the task is not executable, sending error reporting information;
determining whether the task is a dependency task;
in response to that the task is a dependency task, determining whether a fronted task is completed, wherein the fronted task comprises a first fronted task and a second fronted task, and the first fronted task is completed before the second fronted task; and
in response to that both the first fronted task and the second fronted task are completed. scheduling said one of the autonomous mobile machines to execute the task.

2. The autonomous mobile machine control method according to claim 1, further comprising:
obtaining action information from the task information.

3. The autonomous mobile machine control method according to claim 2, further comprising:
in response to the task information comprising the specified information, sending the action information to the autonomous mobile machine, wherein the autonomous mobile machine is specified by the specified information for executing the task.

4. The autonomous mobile machine control method according to claim 2, the action information comprises at least one of suspending an action, continuing to perform an action, or canceling an action.

5. The autonomous mobile machine control method according to claim 2, further comprising:
obtaining task location information and information about the number of times of execution from the task information.

6. The autonomous mobile machine control method according to claim 5, further comprising:
sending the action information, the task location information, and the information about the number of times of execution to the autonomous mobile machine in response to the task information comprising the specified information, wherein the autonomous mobile machine is specified by the specified information for executing the task.

7. The autonomous mobile machine control method according to claim 2, the action information comprises at least one of or a combination of a goods taking action, a goods placing action, or a charging action.

8-11. (canceled)

12. The autonomous mobile machine control method according to claim 1, wherein-controlling one of the autonomous mobile machines to cause said one of the autonomous mobile machines to execute the task comprises:
obtaining state reply information of said one of autonomous mobile machines that meets a task execution condition.

13. The autonomous mobile machine control method according to claim 12, wherein controlling one of the autonomous mobile machines to cause said one of the autonomous mobile machines to execute the task comprises:
scheduling, according to the state reply information, said one of autonomous mobile machines to execute the task.

14. The autonomous mobile machine control method according to claim 13, wherein the state reply information comprises a location of said one of the autonomous mobile machines, a task being executed by said one of the autonomous mobile machines, and an amount of electricity of said one of the autonomous mobile machines.

15. The autonomous mobile machine control method according to claim 13, wherein controlling one of the autonomous mobile machines to cause said one of the autonomous mobile machines to execute the task comprises:
selecting, according to a device location and a task location of each autonomous mobile machine, an autonomous mobile machine closest to the task location to execute the task.

16. The autonomous mobile machine control method according to claim 1, wherein controlling one of the autonomous mobile machines to cause said one of the autonomous mobile machines to execute the task comprises:
in response to that the task has a highest priority, canceling a current task of the autonomous mobile machine closest to a task location.

17. The autonomous mobile machine control method according to claim 1, further comprising:
determining whether the task information corresponds to a question-answer type task;
in response to the task information corresponds to a question-answer type task, selectively obtaining a state reply information from one of the autonomous mobile machines or obtaining an answer text from a memory; and
sending the state reply information or the answer text to a terminal without scheduling any autonomous mobile machine.

18. (canceled)

19. An autonomous mobile machine, comprising a processor, the processor being configured to execute a program instruction so as to implement the following steps:
obtaining a command file and converting the command file to obtain a first text file, wherein the command file is a voice type file and the first text file is a text type file;
obtaining task information from the first text file;
determining whether the task information comprises specified information, wherein the specified information is configured to specify an autonomous mobile machine for executing a task;
in response to that the task information does not comprise the specified information, controlling one of autonomous mobile machines to cause said one of the autonomous mobile machines to execute the task;
obtaining a semantic information by analyzing the first text file;
determining whether an error exists in the semantic information;
in response to an error exists in the semantic information, sending an error reporting information file to a terminal to remind a user to again deliver a command; in response to the error does not exist in the semantic information, causing said one of the autonomous mobile machines to execute the task;
determining whether the task is executable by assessing the relationship between a target associated with the task and environment; and
in response to that the task is not executable, sending error reporting information;
determining whether the task is a dependency task;
in response to that the task is a dependency task, determining whether a fronted task is completed, wherein the fronted task comprises a first fronted task and a second fronted task, and the first fronted task is completed before the second fronted task; and
in response to that both the first fronted task and the second fronted task are completed, scheduling said one of the autonomous mobile machines to execute the task.

20. A management system, comprising a processor, the processor being configured to execute a program instruction so as to implement the following steps:
obtaining a command file and converting the command file to obtain a first text file, wherein the command file is a voice type file and the first text file is a text type file;
obtaining task information from the first text file;
determining whether the task information comprises specified information, wherein the specified information is configured to specify an autonomous mobile machine for executing a task;
in response to that the task information does not comprise the specified information, controlling one of autonomous mobile machines to cause said one of the autonomous mobile machines to execute the task;
obtaining a semantic information by analyzing the first text file;
determining whether an error exists in the semantic information;
in response to an error exists in the semantic information, sending an error reporting information file to a terminal to remind a user to again deliver a command; in response to the error does not exist in the semantic information, causing said one of the autonomous mobile machines to execute the task;
determining whether the task is executable by assessing the relationship between a target associated with the task and environment; and
in response to that the task is not executable, sending error reporting information;
determining whether the task is a dependency task;
in response to that the task is a dependency task, determining whether a fronted task is completed, wherein the fronted task comprises a first fronted task and a second fronted task, and the first fronted task is completed before the second fronted task; and
in response to that both the first fronted task and the second fronted task are completed, scheduling said one of the autonomous mobile machines to execute the task.
